(19) United States
(12) Patent Application Publication
(10) Pub. No.: US 2021/0122567 A1
(43) Pub. Date: Apr. 29, 2021

(54) Trash Storage and Disposal System and Method

(71) Applicants: Sercan Aydin, Verona, NJ (US); Thomas Maoli, Whipanny, NJ (US)

(72) Inventors: Sercan Aydin, Verona, NJ (US); Thomas Maoli, Whipanny, NJ (US)

(21) Appl. No.: 16/664,572

(22) Filed: Oct. 25, 2019

(51) Int. Cl. B65F 1/14; B65F 1/08; B65F 1/16; B65F 7/00

(52) U.S. Cl. CPC B65F 1/1447; B65F 1/08; B65F 1/1457; B65F 1/1431; B65F 2250/1143; B65F 1/163; B65F 7/00; B65F 2001/1692; B65F 2001/1684; B65F 1/1615

(57) ABSTRACT

The present invention discloses a system and method for trash storage and disposal located above and below the surface. The trash storage and disposal system comprises an underground concrete receptacle liner or box, a polyethylene trash storage bucket that sits sub-base in the concrete liner or box with a hook capacity to permit the trash storage bucket to be lifted out of the concrete liner for disposal, a metal ring for a winch connection and the crane to attach from the garbage truck to remove trash from the storage bucket; a spray system provided inside the polyethylene trash storage bucket sprays a peppermint and/or other rodent deterrent and odor repellent and a cover or lid seals the polyethylene trash storage bucket. The cover or lid has a chute style, chimney flue above the ground and the chute style, chimney flue has a lid for dumping refuse by people.

### CROSS-REFERENCE TO RELATED PATENT APPLICATIONS

The present application claims priority to U.S. Provisional Patent Application Ser. No. 62/750,640, filed Oct. 25, 2018.

### TECHNICAL FIELD

The present invention generally relates to a waste management system, particularly to the collecting, storing and disposing of garbage and trash, More specifically the present invention relates to a trash storage and disposal system providing for a clean and odor-free environment and streets.

### BACKGROUND

Waste management has been a major and serious challenge to human kind from a very early age. Around the world, the rate of waste generation is rising with rapid population growth and urbanization. Waste management is critical for sustainable, healthy and inclusive cities and communities, yet it is often overlooked, particularly in low-income countries. While more than one-third of waste in high-income countries is recovered through recycling and composting, only 4 percent of waste in low-income countries is recycled. There is an increase in urbanization leading to exponential growth in garbage generation in highly populated areas. Due to decreased availability of good trash/waste management systems, streets and public trash cans are overloaded with waste. The trash/waste, which is generally organic and inorganic matter, ends up in waste disposal containers on the road side or on road corners. The current waste disposal systems are designed to hold generated waste using a big plastic container or an underground concrete housing with poor design and function. The odor or smell generated from the current waste disposal systems effect the surrounding area where, in the case of public places, it creates an unpleasant environment for the people nearby.

The garbage collection containers which are generally provided on the road side accommodate a limited quantity of the trash and are generally open from the top sides, which creates a very bad odor when the trash inside the containers start decaying and rots, thus producing very unpleasant air around the containers. This unpleasant and smelly air around the trash containers eventually effects tourism and the general well-being of people.

Conventional garbage containers are emptied only after the trash therein becomes overloaded. By this time, the presence of rats and rodents is noticeable. In addition, conventional garbage containers attract the homeless in search of food and anything that may be useable. The trash is then spilled around the corners of the streets, creating an unpleasant environment for pedestrians. Remedial measures are left to the municipality's garbage collection trucks, which collect trash only from the containers but do not clean or pick up the trash spilled from the containers. Street sweepers clean the streets but not every corner of the street where a large quantity of the waste and trash is stacked. This creates a bad odor and unpleasant air leading to health issues as a result of the increased exposure to bacteria and insects generated from the trash.

The problems described above are common in conventional surface or above ground containers. The trash is not collected in an organized manner resulting in significant odors produced by the decomposition of the waste inside the containers. These problems were intended to be addressed by underground collection or storage containers, which are currently being used in some of cities around the world. The underground containers, however, do currently produce unpleasant air, as the waste or trash that is collected is left to rot inside the container emitting smells.

The underground containers, which are employed nowadays, are also difficult to access. The underground container lid or cover is large making it difficult to easily throw trash in the receptacle. Thus, the waste remains sealed inside these underground containers for a long period of time.

There exists a need to provide a waste or trash collection and disposal system, which collects trash or any kind of waste easily from a user(s) and stores the trash in a sealed container. The garbage handling system should provide for a hygienic and clean environment. While this problem has plagued the waste management industry since its inception, a viable solution remains elusive. Some of the proffered, yet unsuccessful, solutions are mentioned as follows.

One example is prior art references CN′4115, which discloses an underground garbage collecting pipe applied to a domestic garbage pneumatic conveying system where the collecting pipe comprises a garbage collecting body. The side wall of the refuse collection tube holder is fixedly mounted to the body. A fixing seat is fixedly installed on the side wall of the garbage collecting pipe body. A moving groove is formed in one side of the fixing seat, and a first spring is welded to the inner wall of the side, away from an opening of the moving groove. One end of the first spring is fixedly provided with a sliding plate connected with the side wall of the sliding groove in a sliding manner. A first through hole is formed in the fixing seat and the sliding plate is connected with the side wall of the first through hole in a sliding manner. The top of the sliding plate penetrates the whole first through hole is extends to the position above the fixing seat. The side away from the first spring of the sliding plate is fixedly provided with a connecting rod. The side away from the sliding plate of the connecting rod extends to the outer side of the fixing seat and a rotary motor is fixedly installed on one side of the top, away from the first spring of the fixing seat. The underground garbage collecting pipe can be used for conveniently and effectively remove garbage, wherein blockage is prevented and a simple structure and use is convenient.

The prior art reference does provide an underground facility to collect the garbage using a pneumatic system but does not provide any provisions to seal the underground container from the ground or surface water which might ingress into the container. Moreover, the prior art as mentioned above is applicable only to the domestic garbage system, and thus, cannot be applied to the busy streets in cities as the pneumatic system is constrained by its limitations.

A further advancement was made by prior art reference, CN′7770, which discloses an underground waste collection system including a collection tank provided in the surface of the label and the button switch provided at the bottom of the inlet collecting tank. The garbage collection means for collecting refuse on the ground along with an underground bin for containing the garbage. The lift allows underground trash rise to the surface making it easy to clean underground trash garbage and also save the floor space. The button uses only a simple circuit design, and the lifter is easy to operate and maintain at lower cost.

The waste collection system as mentioned above is not easy to use and does not provide any means for people to throw trash in, but rather simply provides a lifting means for the trash to be cleaned. Moreover this system does not provide any means to completely seal the container from the surface water and the bad smell which rises from the decomposition of the waste inside the container.

Another prior invention, DE'153C1, provides for a collection station for valuable material or waste containers, which is accessible to the public. The system has several adjacent containers for receiving different materials and is accessible to the public. The waste and/or valuable material containers are arranged in a common externally closed housing with a door through which the user can gain access for filling via openings in the containers. The housing interior has a pyramid shaped roof in the uppermost part with a suction fan installed wherein the pressure side of the fan being connected to an outside vent located in the top of the roof. Each container is associated with a compaction device for compressing the waste and/or valuable material to a fraction of their original volume. The housing is in the form of a kiosk equipped with a telephone booth, a toilet or the like and has fresh air inlets near the bottoms of its walls. The containers have prismatic or pyramidal lids with suction hoses leading to the vent. The waste in the containers are subject to UV radiation to provide germicidal action. The cover plate is located between each radiation device and each container filling opening.

Furthermore, a prior invention CA'361 discloses a waste collection device for the collection of waste having unpleasant odors. The waste collection device comprises a flexible bag having a waste storage compartment for collecting and storing waste therein, a flap for closing said waste storage compartment to a closed position, wherein in said closed position the waste storage compartment is sealed off thereby minimizing escape of waste and odors from said waste storage compartment. A rotatable shaft for opening said waste storage compartment to an open position, the open position providing access to the waste storage compartment, and a body for supporting and storing said bag to facilitate ease of use of the waste collection device.

The above mentioned prior art references provide a closet for dumping waste or trash into, but do not provide an easy means to save time, money and effort of the municipalities and general public. Furthermore, by providing any sophisticated system for waste management cannot solve the main problem which occurs due to the waste that the current invention can solve. The prior art systems mentioned above do not provide an effective solution for keeping cities clean, free from corner trash, and for the prevention of releasing unpleasant odors to the surrounding environment. The prior art systems also fail to address the toll ineffective waste management has on the health and welfare of the public due to the increased risk of exposure to disease and germs.

The problems and limitations of the prior art can be overcome by application of the present invention. With the present inventive system, streets no longer become a hub for trash as the potential for garbage being left on the streets is minimized. Exposure to dirt, odors, and rodents is likewise minimized for the general public and pedestrians as the garbage or trash is held and maintained underground in a sealed cover. The trash container as disclosed herein holds or stores tons of trash before being disposed or discharged into the garbage truck.

### SUMMARY OF THE INVENTION

The present invention provides for a waste or trash collection and storage management system including an underground concrete receptacle, or liner, into which a polyethylene trash storage bucket is placed and covered by a cover or lid.

In one of the preferred embodiments of the invention, a trash storage and disposal system is provided which is located above and below the surface, the system comprising, an underground concrete receptacle liner or box. A polyethylene trash storage bucket that sits sub-base in the concrete liner or box with a hook capacity to permit the trash storage bucket to be lifted out of the concrete liner for disposal. A metal ring for a winch connection and the crane to attach from the garbage truck to remove trash from the storage bucket. The metal ring placed at the top of the polyethylene trash storage bucket is a hot-dip galvanized coated metal arm that connects the trash bucket to the crane. A spray system provided inside the polyethylene trash storage bucket sprays a peppermint and/or other rodent deterrent. An odor repellent and a cover or lid seals the polyethylene trash storage bucket.

In another preferred embodiment of the invention, the cover or lid has a chute style, chimney flue or above the ground. The chute style, chimney flue has a lid for dumping refuse by people. The lid is lifted manually by hand or by foot pedal. A handle is screwed to the lid covering the chute style, chimney flue to manually lift the lid.

In another embodiment of the present invention, a profile skeleton frame made of iron profiles to form a system cover is welded to the bottom side of the cover or lid to enhance strength of the cover or lid. The cover or lid covering the underground trash storage bucket is made of 4 mm metal sheet with an eye drop pattern and coated with hot dip galvanization.

In yet another embodiment of the present invention, a minimum of two gas spring dampers mounted to the cover or lid and the concrete receptacle liner assist in lifting the cover or lid. A minimum of two safety railings are provided to keep the cover or lid of the storage trash bucket on ground level and prevent pedestrians from falling in the trash storage bucket when the cover or lid is opened for trash removal.

In another embodiment of the invention, the cover or lid covering the underground trash storage bucket is designed to prevent rainwater or any water coming from the ground surface. The sub-base or platform is provided on the base of the underground receptacle to properly place the trash storage bucket within the concrete liner after evacuation of the trash and to prevent the trash being stored from falling out of the storage bucket.

Another embodiment of the invention discloses a lock key system. The lock key system is provided on the cover or lid to open and close the storage trash bucket. The lock key system comprises a lock generally made of iron and a key for the lock made of hard polyethylene material, wherein a slot is provided in the concrete receptacle and a male end is mounted on the bottom side of the cover or lid. The lock is locked when the male end enters into the slot. To unlock a key is inserted into an unlocking slot of the lock and is turned or rotated such that the male end of the lock part is released from the slot in the concrete receptacle. After unlocking, the gas spring dampers lift the cover or lid during evacuation.

Another embodiment of the invention provides for a hygienic liquid clamped to the side of the trash receptacle to use after removal of the trash. The hygienic liquid comprises an antibacterial and antifungal cleaning gel to disinfect the bacteria and germs that occur after the disposal of the trash.

Another embodiment of the invention provides for a personal hygiene cleaner including an antibacterial and cleaning gel mounted on the chimney flue, or chute style, with a clamp and nut screw to clean hands after storing waste or trash into the trash storage bucket.

In another embodiment of the invention, the concrete receptacle or liner is made of C35 ready-made concrete in the form of a rectangular prism, wherein the C35 concrete is poured on a 08-010 mm diameter iron truss cage which is mounted in a mold. The fountain cage is placed to make a concrete socket of 135 mm and the concrete manufactured is high strength thick concrete.

In a preferred embodiment of the invention, the lid of the chute style, chimney flue is connected to the chimney by two hinges for opening and closing of the lid. The lid of the chute style, chimney flue is designed to prevent the ingress of water into the chimney.

Another embodiment provides for a connection part of a stainless steel wire connected between a foot pedal and hinge, which transfers force from the foot pedal in order to open the lid of the chute style, chimney flue. The connections are made by salmon bolts, and the wires are fixed to the chimney through supports made in the chute style, chimney flue. The chute style, chimney flue guides the trash to the trash storage bucket.

The invention further provides for a foot pedal made of 3 cm stainless steel pipe with 1 mm wall thickness, wherein the stainless steel wire connected to the foot pedal is 2 mm in diameter. The chimney chute is manufactured from galvanized sheets or stainless steel sheets with polyester-based paint having electrostatic roughing oven powder painted inside and outside to make the chimney chute highly resistant to atmospheric conditions and sun rays. The chute style, chimney flue Is a square shaped waste hole with dimensions of about 400 mm×500 mm and a thickness of about 2 mm.

In another embodiment, the present invention provides for safety railings made of polyethylene material and painted with phosphor paint. The safety railings are mounted on the bottom edges of the cover or lid to provide safety to the pedestrians and personnel.

In another preferred embodiment of the invention, the trash bucket is made of high density polyethylene (HDPE), which is resistant to sudden impacts and loads while filling and discharging the trash. The bottom, corner, edge and side surfaces of the trash bucket consist of thick rib passages resistant to impact and load. A pair of metal handles are provided on both sides of the polyethylene trash storage bucket for tripping and emptying into the garbage truck.

The invention further discloses a method of collecting and discharging trash stored in the trash storage bucket into the garbage truck. The method includes a number of steps, wherein some of the preferred steps are: unlocking a lock of a lid to lift the polyethylene trash storage bucket; connecting a crane of the garbage truck with a galvanized metal ring used for the winch connection to remove the trash; lifting the polyethylene trash storage bucket or container by means of the crane mechanism on the garbage truck; removing the polyethylene trash container from the concrete liner or tank; emptying said trash container into the garbage truck; placing said trash container back on the sub-base within the concrete liner guided by a galvanized sheet metal container guide plate; and closing the cover or lid and locking the lid by a lock key system.

Another embodiment of the invention further comprises the steps of opening the lid of the chute style, chimney flue by pressing the foot pedal or by lifting the cover manually by handle; and spraying hygienic antibacterial and antifungal liquid to the stored trash in the storage bucket.

Another embodiment of the invention provides for a trash storage bucket that can hold more than 3 tons of garbage and can work with regular garbage trucks, which only need a small vintage on the back.

The invention further provides for an underground waste storage with only a chute style, chimney flue above the ground, which provides for a clean environment. With this embodiment of the present invention, the streets remain clean as waste can be easily thrown down the chimney into the trash storage bucket Bad odors and/or any unpleasant air in the surrounding area of the disposal system is diminished as the system is completely closed and includes hygiene antibacterial and antifungal cleaning agents.

There is need for an effective trash/garbage handling system to provide hygiene and prevent health related problems along with safe and clean streets. The trash disposal system of the present invention provides for easy access to aid in eliminating trash on the street. The dirt, smell and rodents will be reduced as the garbage will be held underground in sealed containers until the trash is picked up. Due to reduced trash on the streets from overflowing garbage cans, tourists and residents benefit from clean streets. The trash disposal system holds tons of garbage and without requiring touching a lid to access, wherein access is facilitated by using a foot pedal thereby increasing hygiene. The garbage truck can be fitted with a vintage attached to the back for lifting from the receptacle to the truck.

### BRIEF DESCRIPTION OF DRAWINGS

The embodiments herein will be better understood from the following detailed description with reference to the drawings, in which:

FIG. 1 illustrates a closed display of an outer design of the trash disposal system;

FIG. 2 illustrates the trash disposal system wherein the lid is opened displaying the inner frame work of the system;

FIG. 3 illustrates the trash disposal system depicting the inside of the concrete liner or box and the open lid with safety bar or railings;

FIG. 4 illustrates a demonstration of the lock key system which is used to open the lid of the trash disposal system;

FIG. 5 illustrates a detailed illustration of the foot pedal system designed for opening the chute style, chimney flue cover in the trash disposal system;

FIG. 6 illustrates the locked key position and closed state display of trash disposal system;

FIG. 7 illustrates the trash disposal system displaying safety rails, metal ring and lock housing with the lid open;

FIG. 8 illustrates a top view of the sub-base under the bucket in the trash disposal system;

FIG. 9 illustrates a transparent 3-D representation of the chute style, chimney flue part of the trash disposal system; and

FIG. 10 illustrates a demonstration of the system showing the connection of the garbage truck while standing still and the crane is removing the trash.

### DETAILED DESCRIPTION OF THE INVENTION

The embodiments herein and the various features and advantageous details thereof are explained more fully with reference to the non-limiting embodiments that are illustrated in the following detailed description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

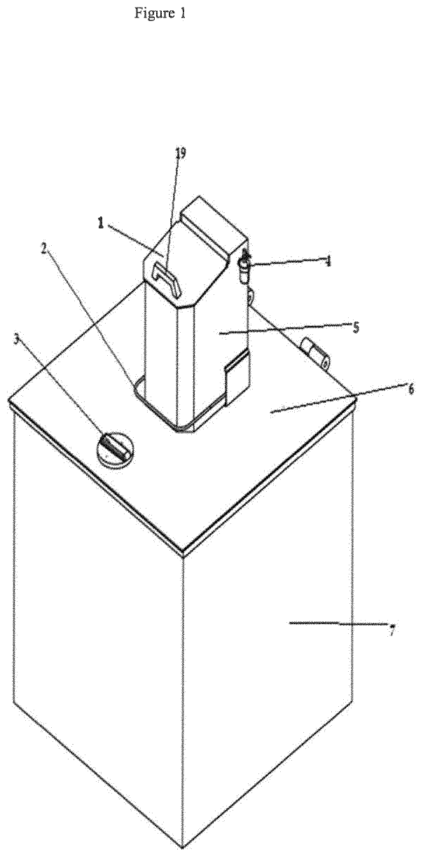

FIG. 1 illustrates a closed view of the waste or trash disposal system. An outer design of the system is displayed disclosing a concrete liner box or tank or receptacle (7) located underground and enclosing a high density polyethylene trash storage bucket (not shown here). A lock system (3) is provided to open and close the trash storage bucket. The lid or cover (6) covers the whole concrete liner or box and is opened or closed by the lock (3) provided at the top front of the cover or lid (6). The system is under the surface up to the cover or lid (6), which is at the surface or ground level. At the middle portion of the cover or lid (6), a chute style, chimney flue (5) is installed. The chute style, chimney flue (5) comprises a square shaped section made up of galvanized metal sheets of a general thickness of 2 mm. The chute (5) is provided with a cover or a lid (1) through which the garbage is thrown into the system. The lid (1) of the chimney chute (5) can be operated in two ways—either manually by just pulling handle (19) up and throwing trash into the container; or by a foot pedal by way of simply pressing the foot pedal (2) causing the lid (1) to open. The mechanism of the foot pedal (2) will be described later. A personal hygiene cleaner (4) is mounted on the chimney chute (5) by clamps and screws. The cleaner (4) is provided for the personnel throwing trash into the container and using the cleaner to clean hands afterwards. The chimney chute (5) guides the trash or garbage thrown from the lid (1) into the trash storage bucket or container.

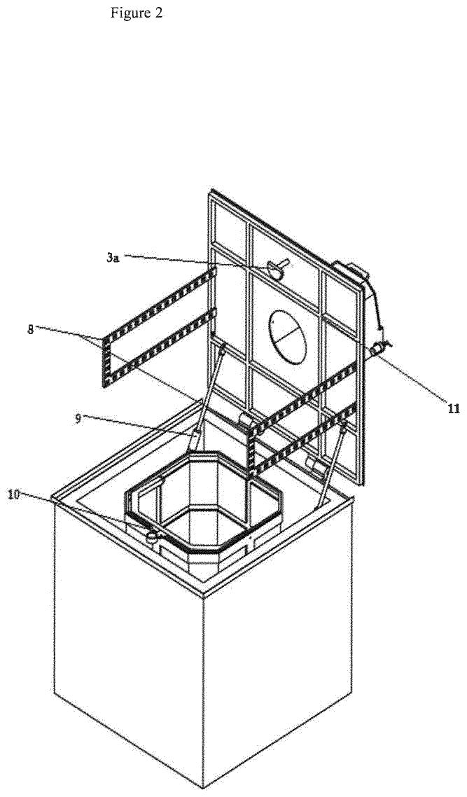

FIG. 2 illustrates the trash disposal system when the lid is opened displaying the inner framework of the system. The cover or lid (6) of the concrete liner (7) is displayed. The lock system (3), as mentioned earlier, has a male end portion (3a), which is to be inserted into the slot or female portion provided at the top side of the concrete liner or receptacle (7) on the inner side. A profile skeleton frame (11) is provided, which is made of iron profiles to form a system cover is welded to the bottom side of the cover or lid to enhance strength of the cover or lid. A hole or provision is displayed in the middle portion of the cover or lid (6) onto which the chimney chute (5) is mounted. At least two safety rails (8) are screwed on the bottom sides of the cover or lid (6). The safety rails (8) are provided to keep the cover or lid (6) at the ground level and keep the pedestrians' safe from falling into the trash container. The profile skeleton (11) also gives an additional support to the system and for the people walking over the cover or lid (6). A number of gas spring chambers (9) are provided, which are connected between the cover or lid (6) and inner side on the base of the concrete liner (7). The gas spring chambers (9) employ pneumatic force when the cover or lid (6) is opened by rotating the lock (3) after the insertion of the key by any officer. The cover or lid (6) is hinged on the opposite side of the concrete container or liner. A metal ring (10) is provided at the top of the trash storage bucket or container (12). The metal ring (10) is used for the point of attachment for the winch connection and crane from the garbage truck to remove the trash.

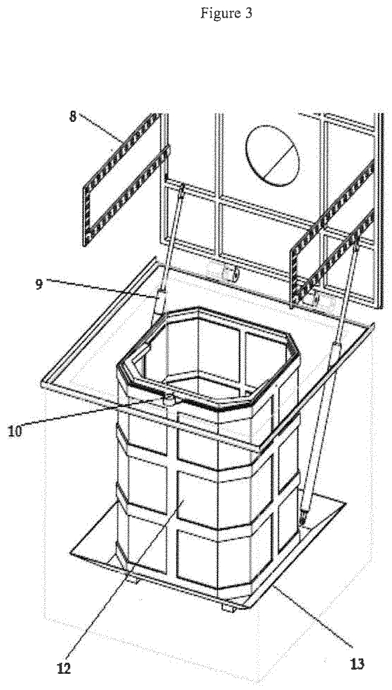

FIG. 3 illustrates the trash disposal system showing the inside of the concrete liner or box and the open lid with safety bar or railings. The trash storage container (12) is placed with a proper balance on a sub-base (13), which is installed at the bottom of the concrete liner (7). The Sub-base (13) of the underground system is what the trash storage bucket sits on within the concrete liner or box. The trash container (12) is provided with at least two handles provided on both sides of the container (12) to be lifted easily during discharging of the trash or garbage into the municipal trucks.

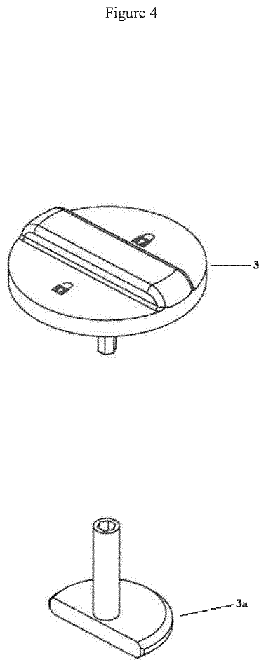

FIG. 4 illustrates a demonstration of the lock key system, which is used to open the lid of the trash disposal system. An upper part (3) and a lower part (3a) are shown. The lock system works in a manner when the officer or the respective personnel inserts the key, into the lock and rotates the lock; the male portion (3a) of the lock system is withdrawn from the female part or slot which is provided on the upper part of the concrete liner on the inside. The gas spring dampers (9) lift the cover or lid (6) of the trash storage container (12).

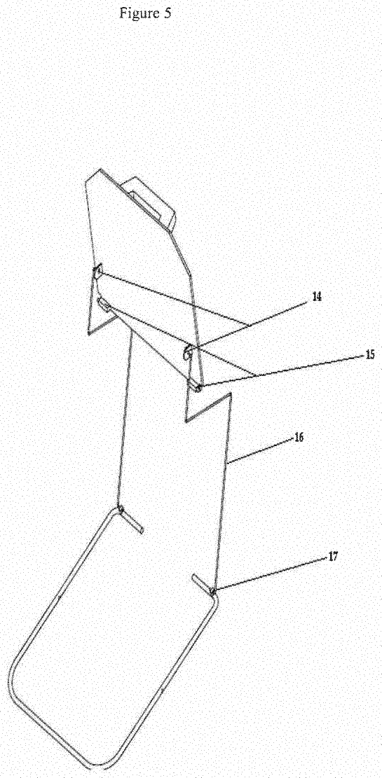

FIG. 5 illustrates a detailed illustration of the foot pedal system designed for opening the chute style, chimney flue cover in the trash disposal system. The foot pedal (2) is connected to a connection part through a stainless steel hinge (17). The connection part (16) is connected to the lid (1) of the chimney chute (5) with the help of stainless steel supports (14). The connection part (16) transfers the force, which is applied to the foot pedal (2) to the lid (1) of the chimney chute (5). As the user presses the foot pedal (2), the lid (1) is opened at the top of the chimney chute (5) for the trash to be thrown into the container (12). The supporters (14) provided on the bottom side of the lid (1) keep the lid opened for a certain duration as long as the user's foot is on the foot pedal (2).

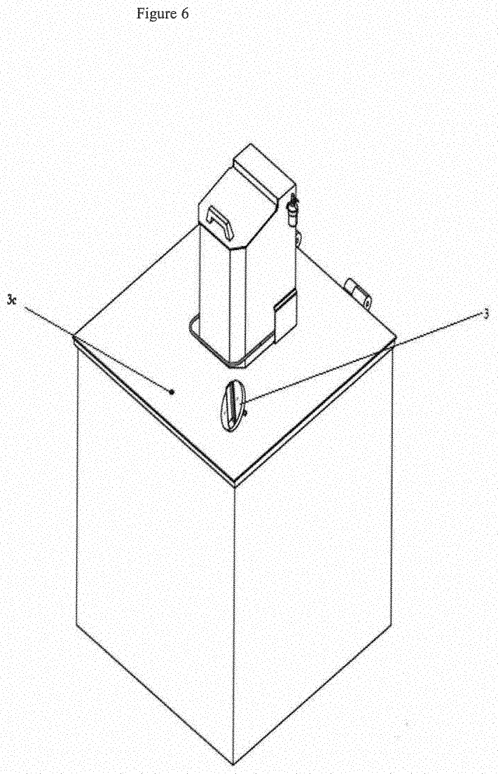

FIG. 6 illustrates the locked key position and closed state display of the trash disposal system.

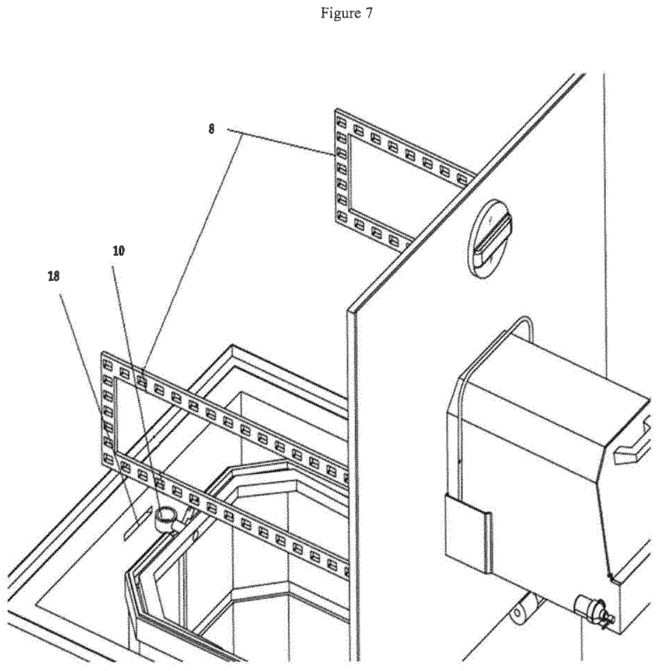

FIG. 7 illustrates the trash disposal system displaying safety rails, metal ring and lock housing with the lid open. The female part or slot (18) as discussed earlier holds the male part (3a) of the lock system when the lid (6) is in a closed position. The metal ring is connected to the hook of the crane of the garbage truck so that the trash container (12) is lifted from the concrete liner or receptacle. The sub-base (13) provided at the bottom of the concrete liner (7) helps the trash container (12) to be placed back into an initial position so that the trash cannot flow or be thrown out of the trash bucket or container (12).

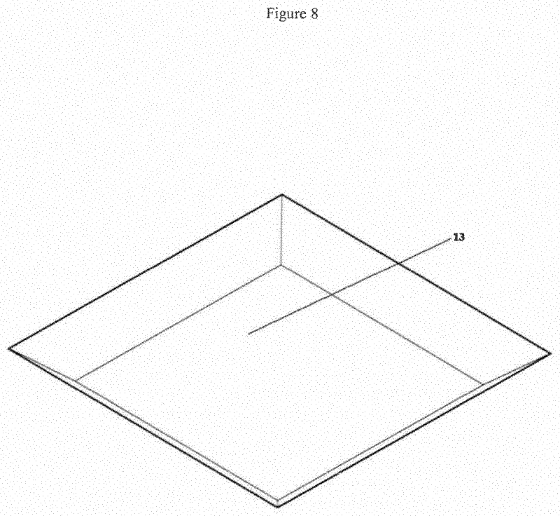

FIG. 8 illustrates a top view of the sub-base (13) under the bucket in the trash disposal system. The sub-base (13) generally has the same shape as that of the trash container (12).

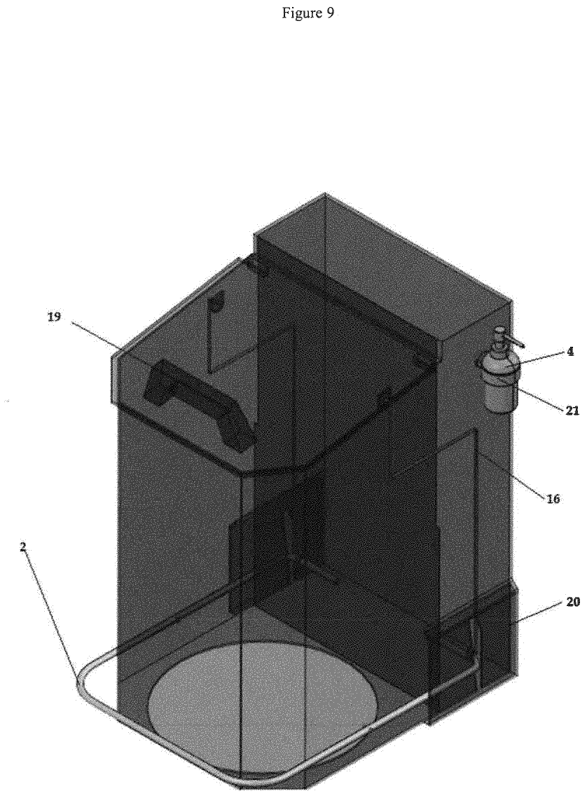

FIG. 9 illustrates a transparent 3-D representation of the chute style, chimney flue part of the trash disposal system. The transparent view of the chimney chute (5) displays the connections of the foot pedal (2) and connection part (16), which transfers the force from the foot pedal (2) to the lid (1) of the chimney chute (5). A stainless steel supporter (20) is provided at the base of the chimney chute (5) in order to protect the system from surface water or rain water. The personal hygiene cleaner (4) is mounted on the side of the chimney chute (5) by means of the clamps (21), which hold the cleaner (4) to the chute (5). The clamps are screwed by means of the salmon bolts into the chimney. The hand cleaning agent prevents any exposure of the hands to microbes or bacteria.

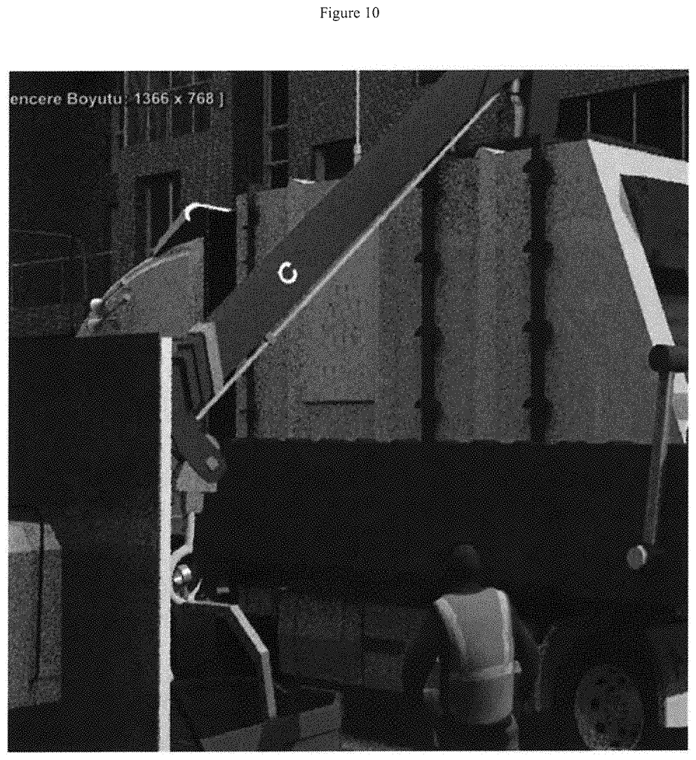

FIG. 10 illustrates a demonstration of the system showing the connection of the garbage truck while standing still and the crane removing the trash. The garbage truck's crane is connected to the trash storage bucket or container (12) and is lifted by the crane of the truck from the receptacle (7) and is disposed into the garbage truck.

The trash disposal system is made of a reinforced concrete liner or box with a trash storage bucket underground, a lid with a 2 gas spring damper to open and close the lid and a chute in the middle of the lid to store the garbage. The trash disposal system provides the storage of the garbage in an underground trash bucket (12) and the removal of the garbage by the opening of a lid with a gas damper (9) operated by personnel who operate the switch for the crane with hook connected to the garbage truck (FIG. 10). A person uses either a hand or foot pedal to open the lid of the chute, discard trash into the chute, which ends up in a polyethylene container in a reinforced concrete box or liner. The foot pedal (2) is connected to the cover or lid (1) through connection part or wire (16), the foot pedal (2) and the connection with the lid (1) are provided the support (17) to keep open the lid. The lid (1) in the chute style, chimney (5) permit trash to enter the trash storage bucket (12). The chute style, chimney (5) ensures the cover is connected to the hinge (15) in a way that the connection is opened. In order to empty the trash, the process for the trash disposal system begins with unlocking the lock on the lid.

The lid opens with the use of gas spring damper. The gas spring damper use is unique for opening a lid for use in the trash disposal system because the mechanism is gas pressure that is used to force the lid open. The lid automatically lifts. Then, a winch connection design is connected to the crane mounted on the truck. The winch is U shaped with the ability to connect on both sides of the trash storage bucket. After the garbage is dumped into the truck, the polyethylene trash storage bucket is placed back in the center of the concrete liner or box by the sub-base (13) and the lid is closed again and locked.

The trash storage bucket is a polyethylene container (12) placed in a concrete liner or box (7) underground. There is a metal fixture on the side of the polyethylene trash storage bucket or container (12) that allows it to be lifted then turned to dump the garbage into the garbage truck. At the top of the polyethylene trash storage bucket (12), there is a galvanized metal arm with a base that can hold the bucket fully (FIG. 2), providing a connection of the bucket to the crane arm and a metal ring welded to the center. High density polyethylene is used to prevent negative impact to sudden bumps and load changes. The bottom, corner and side surfaces of the bucket have thick rib passages and are resistant to impact and thus damage.

The underground waste management system herein disclosed provides a beautiful scene for the tourists and a clean and healthy environment is produced as there is no trash or waste left as debris on the road. The present system reduces the cost of the labor and with this there is also reduction in the time, which was conventionally used. The municipality's revenue increases as tourism increases. In addition, there are empty spaces provided at the underground systems for advertisement thus adding revenue for the municipalities.

It is to be understood, however, that even though numerous characteristics and advantages of the present invention have been set forth in the foregoing description, together with details of the structure and function of the invention, the disclosure is illustrative only, Changes may be made in the details, especially in matters of shape, size, and arrangement of parts within the principles of the invention to the full extent indicated by the broad general meaning of the terms mentioned.

Nomenclature: 1—Lid covering the chute style, chimney flue to throw trash into the trash storage system; 2—Foot pedal; 3—Lock to unlock the lid for trash removal; 3a—Part of lock; 3c—Depicts the hole in which the lock is to be placed; 4—Personnel hygiene cleaner; 5—Chute style, chimney flue that leads to the trash storage bucket; 6—Lid covering the underground trash container flush with the sidewalk when down; 7—Concrete liner or box located underground; 8—Safety railing that keeps people from falling in the trash storage bucket when the lid is open for trash removal; 9—Gas spring damper to aid in opening the lid; 10—Metal ring used for the winch connection and crane to attach from the garbage truck to remove the trash; 11—Profile skeleton which increases the strength of the lid; 12—Trash storage bucket for holding the trash; 13—Sub-base of the underground system on which the trash storage bucket sits within the concrete liner or box; 14—Stainless steel supporter making the connection to the chimney lid. 15—Hinge to help in opening and closing the lid; 16—Used to transfer force from the foot pedal to the lid; 17—Stainless steel hinge for use with the foot pedal; 18—Opening for lock called a lock nest; 19—Handle for lid to manually lift the cover or lid; 20—Stainless steel supporter protecting from fluid and 21—Clamps to affix the personal hygiene product.

What is claimed is:

1. A trash storage and disposal system located above and below the surface, the system comprising:
an underground concrete receptacle liner or box;
a polyethylene trash storage bucket that sits sub-base in the concrete liner or box with a hook capacity to permit the trash storage bucket to be lifted out of the concrete liner for disposal;
a metal ring for a winch connection and the crane to attach from the garbage truck to remove trash from the storage bucket;
a spray system provided inside the polyethylene trash storage bucket sprays a peppermint and/or other rodent deterrent and odor repellent; and
a cover or lid seals the polyethylene trash storage bucket,
wherein the cover or lid has a chute style, chimney flue above the ground, the chute style, chimney flue has a lid for dumping refuse by people, the lid lifted manually by hand or by foot pedal;
a handle screwed to the lid covering the chute style, chimney flue to manually lift the lid;
a profile skeleton frame made of iron profiles to form a system cover is welded to the bottom side of the cover or lid to enhance strength of the cover or lid;
a minimum of two gas spring dampers mounted to the cover or lid and the concrete receptacle liner assist in lifting of the cover or lid;
at least two safely railings to keep the cover or lid of the storage trash bucket on a ground level and to prevent pedestrians from falling in the trash storage bucket when the cover or lid is opened for trash removal;
the cover or lid covering the underground trash storage bucket is designed not to allow rainwater and any water coming from the ground surface;
the sub-base or platform is provided on the base of the underground receptacle to properly place the trash storage bucket within the concrete liner after evacuation of the trash and to prevent the trash being stored from going out of the storage bucket;
a lock key system on the cover or lid to open and close the storage trash bucket; and
a hygienic liquid clamped to the side of the trash receptacle for use after exposure to trash.

2. The system as claimed in claim 1, wherein a personal hygiene cleaner comprises an antibacterial hand cleaning gel, mounted on the chute style, chimney flue with clamp and nut screw to clean hands after storing waste or trash into the trash storage bucket.

3. The system as claimed in claim 1, wherein the hygienic liquid comprises an antibacterial and antifungal cleaning gel to disinfect the bacteria and germs that occur after the disposal of the trash.

4. The system as claimed in claim 1, wherein the concrete receptacle or liner is made of C35 ready-made concrete in the form of a rectangular prism, wherein the C35 concrete is poured on an 8 to 10 mm diameter iron truss cage, which is mounted in a mold.

5. The system as claimed in claim 4, wherein the fountain cage is placed to make a concrete socket of 135 mm and the concrete manufactured is high strength thick concrete.

6. The system as claimed in claim 1, wherein the chute style, chimney flue guides the trash to the trash storage bucket.

7. The system as claimed in claim 1, wherein the lid of the chute style, chimney flue is connected to the chimney by two hinges for opening and closing of the lid and is designed to prevent the ingress of water into the chimney.

8. The system as claimed in claim 1, wherein a connection part of a stainless steel wire connected in between foot pedal and hinge transfers force from the foot pedal in order to open the lid of the chute style, chimney flue, wherein all connections are made by salmon bolts and the wires are fixed to the chimney through supports made in the chute style, chimney flue.

9. The system as claimed in claim 1, wherein the foot pedal is made from 3 cm stainless steel pipe with 1 mm wall thickness, wherein the stainless steel wire connected to the foot pedal is 2 mm in diameter.

10. The system as claimed in claim 1, wherein the chimney chute is manufactured from galvanized sheets or stainless steel sheets with polyester-based paint having electrostatic roughing oven powder painted inside and outside to make the chimney chute highly resistant to atmospheric conditions and sun rays, wherein the chimney style flue chute is a square shaped waste hole with dimensions of about 400 mm×500 mm and a thickness of about 2 mm.

11. The system as claimed in claim 1, wherein the lock system comprises a lock generally made of iron and a key for the lock made of hard polyethylene material, wherein a slot is provided in the concrete receptacle and a male end is mounted on the bottom side of the cover or lid.

12. The system as claimed in claim 1, wherein the lock is locked when the male end enters into the slot and to unlock a key is inserted into an unlocking slot of the lock and is turned or rotated such that the male end of the lock part is released from the slot in the concrete receptacle and after unlocking the gas spring dampers lift the cover or lid during evacuation.

13. The system as claimed in claim 1, wherein the cover or lid covering the underground trash storage bucket is made of 4 mm sheet with an eye drop pattern and coated with hot dip galvanization.

14. The system as claimed in claim 1, wherein the safety railings made of polyethylene material and painted with phosphor paint, are mounted on the bottom edges of the cover or lid to provide safety to pedestrians and personnel.

15. The system as claimed in claim 1, wherein a metal ring placed at the top of the polyethylene trash storage bucket is a hot-dip galvanized coated metal arm that connects the trash bucket to the crane.

16. The system as claimed in claim 1, wherein the trash bucket is made of high density polyethylene (HDPE) which is resistant to sudden impacts and loads while filling and discharging the trash, wherein bottom, corner, edge and side surfaces of the trash bucket consist of thick rib passages resistant to impact and load.

17. The system as claimed in claim 1, wherein metal handles are provided on both sides of the polyethylene trash storage bucket for tripping and emptying into the garbage truck.

18. A method of disposing a collected trash from a polyethylene trash storage bucket into a garbage truck being fitted with a crane, the method comprising:
unlocking a lock of a lid to lift the polyethylene trash storage bucket;
connecting the crane of the garbage truck with a galvanized metal ring used for the winch connection to remove the trash;
lifting of the polyethylene trash storage bucket or container by means of the crane mechanism on the garbage truck;
removing the polyethylene trash container from the concrete liner or tank;
emptying said trash container into the garbage truck;
placing said trash container back on the sub-base within the concrete liner guided by a galvanized sheet metal container guide plate; and
closing the cover or lid and locking the lid by a lock key system.

19. The method as claimed in claim 18, wherein collecting trash comprises a step of opening the lid of the chute style, chimney flue by pressing a foot pedal or by lifting the cover manually by handle.

20. The method as claimed in claim 18, wherein storing trash comprises a step of spraying hygienic antibacterial and antifungal liquid to the stored trash in the storage bucket.
